(19) United States
(12) Patent Application Publication
(10) Pub. No.: US 2011/0000502 A1
(43) Pub. Date: Jan. 6, 2011

(54) Automatic Flossing Device

(76) Inventor: Robert Eubank, Allen, TX (US)

Correspondence Address: Jerod E. Tufte;Tufte Law Office, PC, 106 W. Broadway, PO Box 139, Steele, ND, 58482, US

(21) Appl. No.: 12/496,423

(22) Filed: Jul. 1, 2009

(51) Int. Cl. A61C 15/04

(52) U.S. Cl. 132/323

(57) ABSTRACT

A powered dental flossing device includes a gyroscopic or motion sensor. Powered functions of the flossing device, including floss winding, linear and transverse agitation or oscillation of the floss, and LED illumination are all activated and deactivated as a function of changes in the detected orientation of the flossing device, eliminating the need for manual switches and providing an intuitive user experience to increase speed and convenience of flossing.

### BACKGROUND OF THE INVENTION

1. Field of the Invention

This invention relates to dental flossing devices and more particularly to flossing devices having power driven means for winding and reciprocating a working area of dental floss.

2. Background

Although dental flossing is broadly recognized as having great importance to dental health, the difficult and tedious nature of flossing causes many people to floss infrequently or not at all. To ease the chore of flossing and encourage more people to floss regularly, a variety of flossing devices have been developed. These prior art flossing devices improve the user's ability to maintain tension on the floss, and insert the floss into the interdental spaces. Various of the powered flossing devices on the market or known in the art have powered winding of floss, agitation or reciprocation of floss to assist insertion of the floss between teeth or to aid in the cleaning action. These powered flossing devices are operated by one or more manually operated switches to activate the winding or agitation motors.

Power flossing devices are known to provide motion of the working portion of floss both along the length of the floss and transverse to the length of the floss. Examples of such power flossing devices are described in U.S. Pat. Nos. 5,579,786, 5,921,254, 7,140,373, and 7,311,108. These prior art power flossing devices all require manual user activation of the powered floss movement using a button or a switch.

Another power dental flossing device is found in U.S. Pat. No. 5,279,314 to Poulos, which describes a flossing device that has enhanced automatic activation features. The automatic activation features described by Poulos include an infrared beam running generally parallel to the floss. The beam is broken when the floss approaches the contact point between the teeth and triggers activation of the flossing device's motor. A further automatic activation feature described by Poulos is the use of a pressure sensor to detect contact between floss and the user's teeth and automatically change the powered motion of the floss.

An improved automated flossing device is needed to provide the degree of ease of use and rapid flossing ability required for users to regularly and conveniently floss their teeth. The flossing device of the present invention improves on prior art powered flossing devices by providing a simple and intuitive means for activating and deactivating the powered features of the flossing device. Through the use of an integrated sensor, the flossing device of the present invention can automatically detect when it has been picked up and oriented for use. The use of a gyroscopic or inertial sensor to detect the flossing device's orientation simplifies the construction of the device and makes it less susceptible to water, dirt and other environmental factors inherent in flossing. The usage methods enabled by the flossing device of the present invention provide the user with greater convenience and efficiency compared with powered flossing devices in the prior art.

### BRIEF SUMMARY OF THE INVENTION

The present invention overcomes the problems associated with prior art flossing devices. This is accomplished by providing powered floss agitation and winding as well as an LED for illuminating the mouth while flossing, and further providing convenient, intuitive means for activating and deactivating the flossing devices components as a function of the flossing device's orientation.

The recent development of inexpensive Microelectromechanical System (MEMS) sensors has spurred new developments in the smart phone and electronic gaming fields. For example, the Apple iPhone, HTC Google G1, and the controller for the Nintendo Wii all contain three-axis accelerometers that are used in these devices to provide an improved, intuitive user experience with the device. The present invention builds on the prior art powered flossing devices and provides a new flossing device that is activated simply by raising it from a rest position to the orientation in which it is used to clean the user's teeth. Accordingly, the problem of undue time and inconvenience in flossing is solved by providing a simple to use automatic flosser that triggers agitation and winding operations automatically without user-operated switches based on the detected orientation of the flossing device.

### BRIEF DESCRIPTION OF THE SEVERAL VIEWS OF THE DRAWINGS

FIG. 1 is a side view of a power flossing device embodying the invention.

FIG. 2 is a top view of a power flossing device embodying the invention.

FIG. 3 is a flowchart diagram illustrating the operation of a power flossing device embodying the invention.

### DETAILED DESCRIPTION

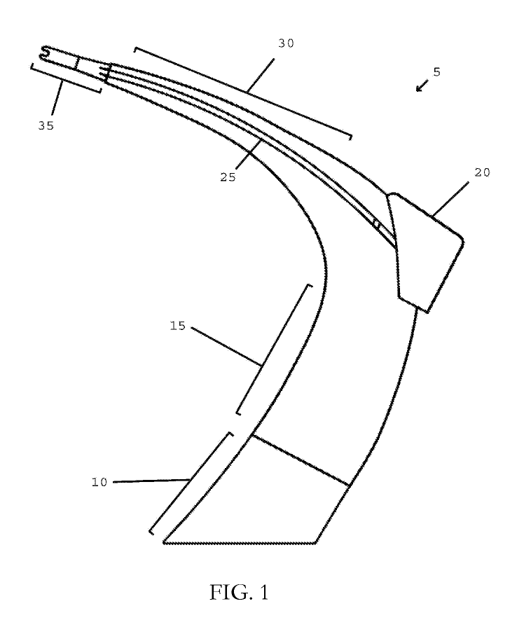

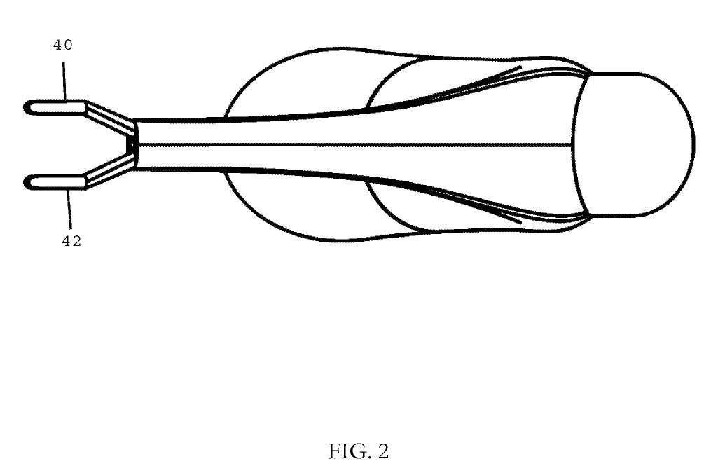

A powered flossing device 5 embodying the invention is shown in FIG. 1. The powered flossing device 5 generally includes a base 10, handle 15, floss cartridge 20, floss channel 25, neck 30, and head 35. As shown in FIG. 2, The head 35 is comprised of two prongs 40, 42. The flossing device 5 is designed with a flat base 10 such that when placed at rest on its base between uses, it has a repeatable, consistent orientation.

In the embodiment shown in FIG. 1, the flossing device 5 has an easily replaced floss cartridge 20. To load a new floss cartridge 20 onto the device, an exposed loop of floss is pulled against the spring tension of the cartridge and looped over the ends of the prongs 40, 42, so that the floss runs from the cartridge 20, inside the channel 25, across the ends of the prongs 40, 42, and back to the cartridge 20 in the channel 25 on the opposite side. A power source and one or more electric motors for winding and oscillating the floss are inside handle 15 and base 10 and are of conventional type known in the art of electric toothbrushing and flossing devices. In the preferred embodiment, disposable alkaline batteries are employed as a power source in order to minimize production and end-user costs, but as the novel features of the present invention relate primarily to activating the powered features of the flossing device as a function of the device orientation, the internal electrical and motor configurations are not further described herein.

The flossing device 5 further comprises a sensor capable of determining the device's orientation. The sensor may be of a variety of types generally referred to as acceleration sensors, inertial sensors, motion sensors, or gyroscopic sensors. Analog Devices and STMicroelectronics are two industry sources for Micro-electro mechanical systems (MEMS) sensors. The MEMS sensor is coupled to a logic circuit that activates and deactivates the flossing device's 5 motors and LEDs during use, as described in more detail immediately below.

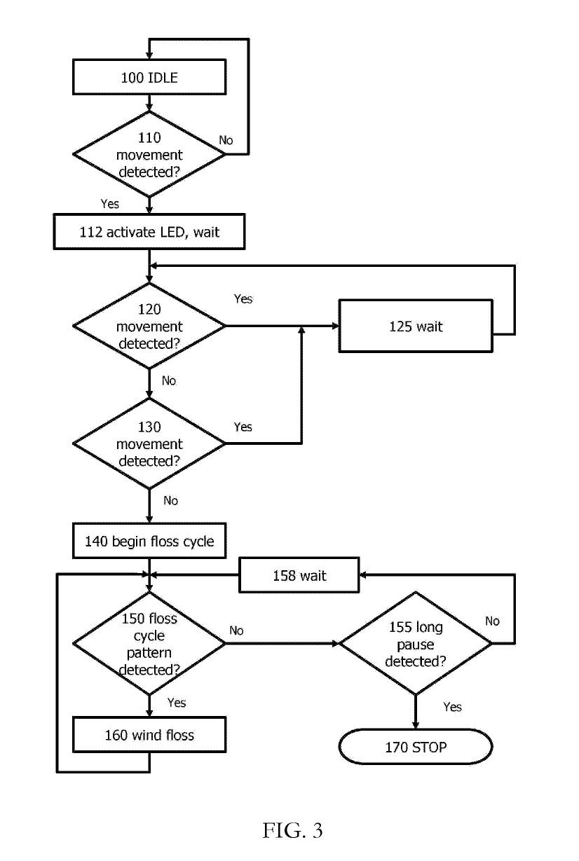

The operation of the automatic activation features of the preferred embodiment of the present invention are shown in the flowchart diagram of FIG. 3. For purposes of this description, it is assumed that the flossing device's 5 orientation is measured in terms of degrees relative to a reference position where the reference position is assumed to zero. For example, when at rest on its base, the orientation is measured to be zero. When laying on its side the orientation would be measured to be 90 degrees. At rest, the flossing device 5 rests on base 10 on a counter, table, or other flat surface and has a substantially vertical orientation. At step 100, the device is idle. In this idle state, the device is in a sleep mode to conserve power and it periodically, approximately every one second or so, check to see if movement has been detected, as shown at step 110. If no movement has been detected, or in other words if no change in orientation is detected, the device returns to its idle state. If movement is detected at 110, the LED is turned on at step 112 followed by a brief wait cycle of approximately 0.1 seconds. The next step 120 begins a new cycle of repeated movement detection, only at more frequent intervals of approximately 0.1 seconds. As shown in steps 120, 125, and 130, the movement is repeated tested on this shorter interval until two successive tests indicate that no movement has been detected. After two successive tests indicating no movement, at steps 120 and 130, the flossing device 5 initiates a flossing cycle at step 140. The flossing cycle is initiated after detection of a brief pause in the movement of the flossing device 5 because in using the flossing device 5, the user will pause briefly upon contact with each tooth. This pause is the action detected by the flossing device and is used to indicate a new flossing action is about to begin. The flossing cycle includes activation of electric motors to oscillate floss back and forth along its length. In alternative embodiments, other modes of agitation or movement of the floss may also be triggered as a function of the device orientation.

At step 150, the flossing device 5 begins a cycle of checking the orientation at brief intervals to detect motion corresponding to insertion and extraction of the floss between two teeth. In ordinary use, the user will tilt the flossing device 5 down and then up to floss between lower teeth and the user will tilt the flossing device 5 up and then down to floss between upper teeth. Using the conventions described above, where the substantially vertical rest position is zero, a tilt down corresponds to an increase in degrees relative to vertical and a tilt up corresponds to a decrease in degrees relative to vertical. A floss cycle pattern is defined as either (a) an increase of approximately 5 degrees followed by a decrease of approximately 5 degrees, or (b) a decrease of approximately 5 degrees followed by an increase of approximately 5 degrees. At step 150, the flossing device tests to see if a floss cycle pattern has been detected. If it has, then at step 160 the agitation means is stopped, the winding means of the flossing device 5 is activated to wind a new section of floss between the prongs 40, 42, and the agitation means is restarted. If a floss cycle pattern is not detected at step 150, then at step 155 the flossing device 5 tests to see if a long pause has been detected. A long pause is indicated by no detected changes in orientation for a period of two seconds. If no long pause is detected, a brief wait is initiated at step 158 before restarting the test at 150. If a long pause is detected, the device powers down as shown in step 170.

In alternative embodiments of the present invention, the detection of a momentary pause in motion of the flossing device is not required. In these alternative embodiments, the changes in orientation irrespective of whether there is a pause in the motion of the device are sufficient to correctly trigger activation and deactivation of the flossing device. In other embodiments, the flossing device may be activated upon detection of the initial motion when the flossing device is picked up, and later deactivated upon detection of a longer threshold period of no detected motion. The detection of patterns in the motion to activate a floss winding function between each tooth is also a feature of the preferred embodiment but not a required feature of the invention. The flossing device may be configured, as is known in the art, to incrementally wind the floss from a first reel to a second reel simultaneous with operation of an agitation or oscillation function.

Various modifications, substitutions, and changes may be made in the structure and embodiments shown without departing from the concept of the invention. Therefore, the scope of the invention is to be determined by the terminology of the following claims and the legal equivalents thereof.

1) An apparatus for flossing teeth, the apparatus comprising a powered flossing device, a means for detecting the orientation of said flossing device, and a means for activating and deactivating said powered flossing device as a function of the detected orientation of the flossing device.

2) A powered flossing device having a housing, a power source, a length of floss on a spool, and a powered means for rotating said spool, comprising:
means for detecting the orientation of said flossing device and activating said powered means for rotating said spool as a function of the detected orientation of said flossing device.

3) The powered flossing device of claim 2 further comprising a means for illuminating the user's teeth and means for activating said means for illuminating as a function of the detected orientation of said flossing device.
